(19) United States
(12) Patent Application Publication
(10) Pub. No.: US 2026/0126510 A1
(43) Pub. Date: May 7, 2026

(54) RF SIGNAL ANGLE OF ARRIVAL IDENTIFICATION WITH ADJUSTABLE ANTENNA ARRAY

(71) Applicant: VIAVI SOLUTIONS INC., Chandler, AZ (US)

(72) Inventors: Eduardo Inzunza, Los Gatos, CA (US); Hyuck In Kwon, Gyeonggi-Do (KR); Seong-Mann Joe, Incheon (KR)

(73) Assignee: VIAVI SOLUTIONS INC., Chandler, AZ (US)

(21) Appl. No.: 19/421,194

(22) Filed: Dec. 16, 2025

Related U.S. Application Data
(63) Continuation-in-part of application No. 19/097,117, filed on Apr. 1, 2025.
(60) Provisional application No. 63/689,381, filed on Aug. 30, 2024.

(51) Int. Cl. G01S 3/04; G01S 3/48

(52) U.S. Cl. CPC G01S 3/043; G01S 3/046; G01S 3/48

(57) ABSTRACT

According to examples, an apparatus for identifying an angle of arrival of RF signals from an RF emitter may include a chassis, an antenna array spacer, and a first RF antenna and a second RF antenna connected to the antenna array spacer. The first RF antenna and the second RF antenna may movable along the antenna array spacer. In addition, the apparatus may include an antenna controller to output combined signals received by the first RF antenna and the second RF antenna and adjust phases of the RF signals received by the first RF antenna and the second RF antenna. The apparatus may further include an interface controller to output the combined signals to a test device having a display, in which the test device may include a processor to determine an angle of arrival of the combined signals.

### PRIORITY

This application is a Continuation-in-Part of commonly assigned and co-pending U.S. Patent Application No. 19/097,117, filed April 1, 2025, titled “RF INTERFERENCE LOCALIZATION AND VISUALIZATION,” which claims priority to U.S. Provisional Patent Application No. 63/689,381, filed August 30, 2024, titled “RF INTERFERENCE LOCALIZATION AND VISUALIZATION,” the disclosures of which are hereby incorporated by reference in their entireties.

### TECHNICAL FIELD

The disclosure relates generally to apparatuses for detecting radio frequency (RF) signals. The disclosure relates more particularly to apparatuses for identifying an angle of arrival of RF signals from an RF emitter and for displaying images of an environment in which the RF signals are detected with information regarding the identified angle of arrival of the RF signals.

### BACKGROUND

A cell site, also known as a cell tower or cellular base station, includes a radio, an antenna and electronic communications equipment that are often mounted on towers or rooftops to support cellular communication. The cell site communicates over the air with user equipment (UE) or customer premise equipment (CPE), and has a network interface via wireless or wireline networks, which may include fiber optic cables and coaxial cables. Cellular mobile devices communicating with cell sites generally constitute a local subnetwork, while the connection between the cell site and the rest of the world may be referred to as a backhaul link or simply backhaul.

### BRIEF DESCRIPTION OF THE DRAWINGS

Features of the present disclosure are illustrated by way of examples shown in the following figures. In the following figures, like numerals indicate like elements, in which:

FIG. 1 shows a test environment in which an apparatus for identifying an angle of arrival of radio frequency (RF) signals from an RF emitter may be employed, according to an example of the present disclosure;

FIG. 2 shows a block diagram of the apparatus for identifying an angle of arrival of RF signals from an RF emitter shown in FIG. 1, according to an example of the present disclosure;

FIG. 3 shows a block diagram of a system for identifying an angle of arrival of RF signals from an RF emitter, according to an example of the present disclosure;

FIG. 4 shows a block diagram of the test device shown in FIG. 3, and particularly, the processor and the memory of the test device, according to an example of the present disclosure;

FIG. 5A shows a graphical representation of a MUSIC spectrum resulting from an example spectrum determination operation, according to an example of the present disclosure;

FIG. 5B shows a diagram of a heat map that corresponds to the graphical representation shown in FIG. 5A, according to an example of the present disclosure;

FIG. 6 shows a flow diagram of a method for identifying and visualizing an angle of arrival of RF signals from an RF emitter, according to an example of the present disclosure;

FIGS. 7A and 7B, respectively, show diagrams of a system for identifying and visualizing a direction or angle of arrival of an RF emitter, according to an example of the present disclosure;

FIGS. 8A-8C, respectively, show perspective views of an apparatus for identifying an angle of arrival of RF signals from an RF emitter, according to an example of the present disclosure; and

FIG. 8D shows a diagram of the antenna array spacer with a plurality of antenna spacer marks, according to an example of the present disclosure.

### DETAILED DESCRIPTION

For simplicity and illustrative purposes, the present disclosure is described by referring mainly to examples thereof. In the following description, details are set forth in order to provide an understanding of the present disclosure. It will be readily apparent however, that the present disclosure may be practiced without limitation to these details. In other instances, some methods and structures have not been described in detail so as not to unnecessarily obscure the present disclosure.

Throughout the present disclosure, the terms “a” and “an” are intended to be at least one of a particular element. As used herein, the term “includes” means includes but not limited to, the term “including” means including but not limited to. The term “based on” means based at least in part on. In addition, relative terms such as “approximately,” “about,” “substantially,” “around,” and similar expressions, when used in connection with a quantity or condition, should be understood to include the stated value as well as variations dictated by context. Such variations may account for measurement error, manufacturing or assembly tolerances, usage conditions, or other practical considerations. These terms should also be interpreted as covering the range defined by the absolute values of the stated endpoints. For example, the expression “from about 5 to about 10” encompasses the range “from 5 to 10.” In some contexts, the relative terminology may also denote a variation of plus or minus a percentage (e.g., ±1%, ±5%, ±10%, or more) of the referenced value.

Radio frequency (RF) interference that impacts cellular communications, e.g., 4G Long Term Evolution (LTE) and/or 5G New Radio (NR) networks, is commonly generated by RF emitters such as other radios, external devices, etc. Disclosed herein are apparatuses and systems for identifying and visualizing angles or directions of RF signals from RF emitters. Particularly, an apparatus disclosed herein may include a first RF antenna and a second RF antenna that are movably mounted on an antenna array spacer. The spacing between the first RF antenna and the second RF antenna may be adjusted to vary the frequency of the RF signals being tested by the apparatus. For instance, the spacing between the first RF antenna and the second RF antenna directly influences a frequency of an RF signal being tested by the first RF antenna and the second RF antenna.

The apparatus disclosed herein may also include a camera positioned in line with the first and second RF antennas to capture images of objects in the field of view of the camera and in the direction that the first and second RF antennas face. The apparatus may communicate the captured images and the detected RF signals to a test device that may determine the angle or direction of arrival of the detected RF signals. The test device may determine the angle or direction of arrival through implementation of any suitable technique, including, for instance, the multiple signal classification (MUSIC) algorithm. The test device may further display the received images and may display the determined angle or direction of arrival as an overlay on the displayed images. For instance, the test device may include a display and the determined angle or direction of arrival may be displayed as a heat map on the displayed image.

Through implementation of the features of the present disclosure, a user, such as a technician, may identify the direction or angle of arrival of RF signals from RF emitters. Identification of the direction or angle of arrival of the RF signals may enable the technician to determine potential sources of RF interference. In addition, knowledge of the potential sources of RF interference may enable for such RF interference to be addressed and/or mitigated.

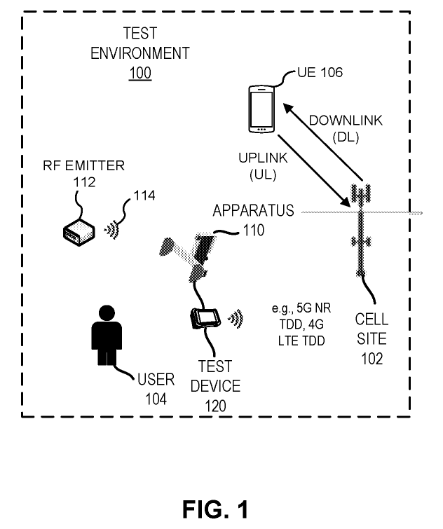

FIG. 1 shows a test environment 100 in which an apparatus 110 for identifying an angle of arrival of radio frequency (RF) signals from an RF emitter may be employed, according to an example of the present disclosure. It should be understood that the test environment 100 and the apparatus 110 may include additional features and that some of the features described herein may be removed and/or modified without departing from the scopes of the present disclosure.

The test environment 100 may include a cell site 102, which may include a cell tower or cellular base station having antennas and electronic communications equipment to support cellular mobile service. The test environment 100 may be based on the cell size of the cell site 102. A customer of a cellular service provider may use a user equipment (UE) 106 for communicating with the cell site 102. The communications include uplink (UL) and downlink (DL) transmissions supported by the cell site 102. The UE 106 may be a smartphone, a tablet computer, a laptop computer, or other wireless device.

A user 104, such as a cellular service provider technician, may use the apparatus 110 to determine an angle of arrival of an RF signal 114 from an RF emitter 112. In other words, the user 104 may use the apparatus 110 to determine from which direction RF signals 114 from the RF emitter 112 is detected. As discussed in greater detail herein, the apparatus 110 may communicate the detected RF signals along with direction information to a test device 120, which may process the detected RF signals to determine the angle of arrival of the detected RF signals. The apparatus 110 may also include a camera and may communicate captured images to the test device 120. The test device 120 may include a display on which the test device 120 may display the received images and an indication of the determined angle of arrival of the detected RF signals, for instance, as a heat map.

In an example use case, the user 104 may use the apparatus 110 and the test device 120 to determine the angle of arrival of RF signals 114 to identify directions at which RF emitters 112 may be located in the test environment 100. In some instances, RF emitters 112 may be generating RF signals may that interfere with the uplink or downlink communications of the UE 106 with the cell site 102. The RF emitters 112 may be external devices, for instance, broadband amplifiers, video cameras, industrial machinery, and/or the like; as well as other communication transmitters, for instance, cellular base stations, a broadcast station, a safety and government radio, an amateur radio repeater, a fixed microwave, a satellite earth station, and/or the like.

As the RF signals 114 may affect the proper operation of the cell site 102 with the UE 106, it may be important to identify the directions in which the RF emitters 112 are located. By identifying the directions in which the RF emitters 112 are located, potential interference caused by the RF emitters 112 may be detected and, in some instances, resolved. For instance, faulty or poorly shielded equipment may be replaced, RF shielding materials may be employed on the RF emitters 112, RF emitters 112 may be relocated or reoriented, operating frequencies of the RF emitters may be modified, and/or the like.

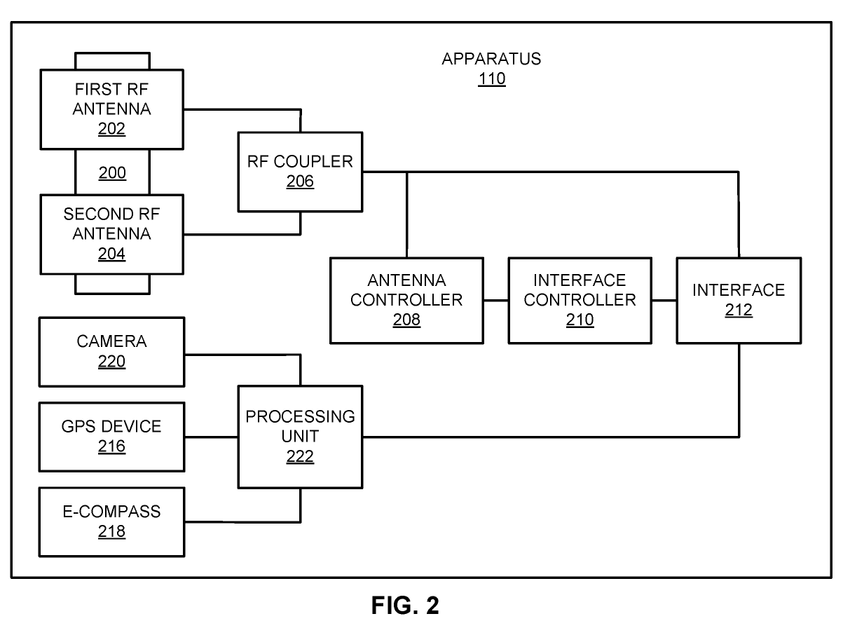

FIG. 2 shows a block diagram of the apparatus 110 for identifying an angle of arrival of RF signals 114 from an RF emitter 112 shown in FIG. 1, according to an example of the present disclosure. It should be understood that the apparatus 110 depicted in FIG. 2 may include additional features and that some of the features described herein may be removed and/or modified without departing from the scopes of the present disclosure.

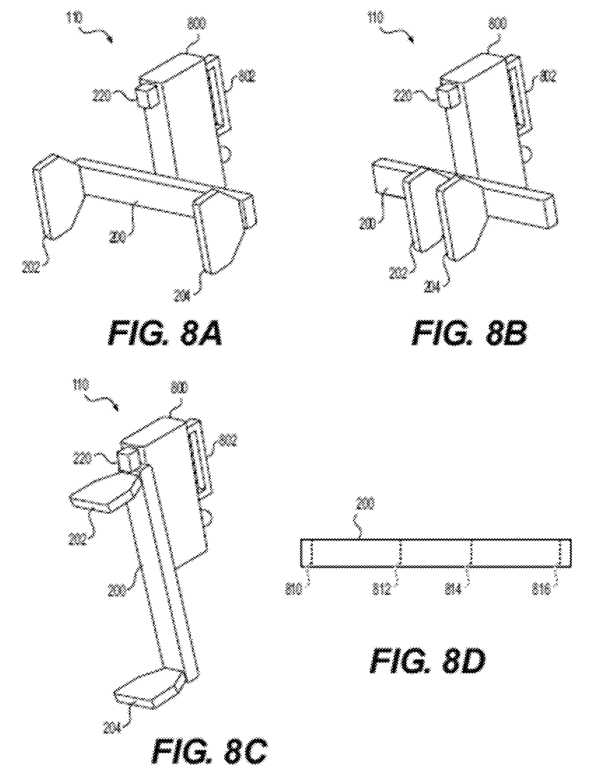

As shown in FIG. 2, the apparatus 110 may include a chassis 800 (shown in FIGS. 8A-8C), an antenna array spacer 200, a first RF antenna 202, and a second RF antenna 204. The first RF antenna 202 and the second RF antenna 204 may form a phased array antenna system. The antenna array spacer 200 may be mounted to the chassis 800 and the first RF antenna 202 and the second RF antenna 204 may be connected to the antenna array spacer 200. According to examples, and as discussed in greater detail herein below, the antenna array spacer 200 may be mounted to the chassis 800 in a manner that enables an orientation of the antenna array spacer 200 to be rotatable with respect to the chassis 800.

According to examples discussed hereinbelow, the first RF antenna 202 and the second RF antenna 204 may be mounted on the antenna array spacer 200 in a movable configuration. In one regard, the distance between the first RF antenna 202 and the second RF antenna 204 may be varied by moving either or both of the first RF antenna 202 and the second RF antenna 204 along the antenna array spacer 200. As discussed herein, the spacing distance between the first RF antenna 202 and the second RF antenna 204 is defined by the wavelength of the signal under test by the apparatus 110.

The first RF antenna 202 and the second RF antenna 204 may each be RF directional antennas that may detect RF signals emanating from a direction in which the first RF antenna 202 and the second RF antenna 204 is facing. Particularly, in some examples, the first RF antenna 202 and the second RF antenna 204 may receive greater radio wave power in the specific direction in which the first and second RF antennas 202, 204 are facing and may thus focus the direction in which RF energy is received. According to examples, the first and second RF antennas 202, 204 may each have a directivity better than ±35°.

The apparatus 110 may also include an RF coupler 206 and an antenna controller 208. The RF coupler 206 may receive and couple signals detected by the first RF antenna 202 and the second RF antenna 204 into combined signals. The RF coupler 206 may also provide the combined signals to the antenna controller 208. In addition, the antenna controller 208 may output the combined signals received from the RF coupler 206 to an interface controller 210.

The interface controller 210 may output the combined signals to the test device 120 through an interface 212. The test device 120 may perform a multiple signal classification (MUSIC) algorithm to estimate the direction of arrival of the signals from the first RF antenna 202 and the second RF antenna 204. The interface 212 may include an Ethernet interface, an optical interface, a coaxial interface, an infrared interface, an RF interface, a universal serial bus (USB) interface, a Wi-Fi interface, a cellular network interface, or the like. The interface controller 210 may also receive instruction signals from the test device 120 through the interface 212. In some examples, the apparatus 110 may receive power from the test device 120 through the interface 212.

The antenna controller 208 and/or other components may form a software defined radio. The software defined radio may be defined as a radio communication system where traditional hardware components such as mixers, filters, amplifiers, modulators/demodulators, and detectors are implemented using software.

The apparatus 110 may further include a global positioning system (GPS) device 216 and an electronic compass (E-compass) 218. The GPS device 216 may calculate the geo-location of the apparatus 110 and the electronic compass 218 may determine the azimuth, the elevation, and the polarization of the apparatus 110. The apparatus 110 may communicate the detected information to the test device 120 through the interface 212.

As also shown in FIG. 2, the apparatus 110 may include a camera 220 and a processing unit 222. The camera 220 may capture images of objects and an environment in a field of view of the camera 220. The camera 220 may be a digital still camera or a digital video camera. According to examples, the camera 220 may be positioned in line with the first and second RF antennas 202, 204 such that the camera 220 faces a common direction as the first and second RF antennas 202, 204. In this regard, the camera 220 is positioned to capture images of objects to which the first and second RF antennas 202, 204 are facing. In some examples, the camera 220 is an autofocus camera. In addition, the camera 220 may communicate captured images to the test device 120.

The processing unit 222 may control the camera 220, e.g., may control the camera 220 to capture images. The processing unit 222 may also control the GPS device 216 and the E-compass 218.

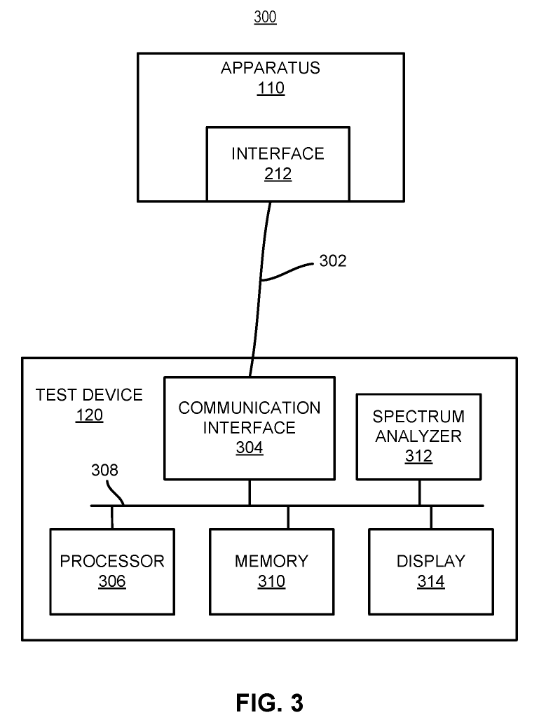

FIG. 3 shows a block diagram of a system 300 for identifying an angle of arrival of RF signals from an RF emitter, according to an example of the present disclosure. It should be understood that the system 300 depicted in FIG. 3 may include additional features and that some of the features described herein may be removed and/or modified without departing from the scopes of the present disclosure.

As shown, the system 300 may include the apparatus 110 shown in FIGS. 1 and 2 and the test device 120 shown in FIG. 1. The apparatus 110 is shown as being in communication with the test device 120 through a cable assembly 302. As shown, the cable assembly 302 may be connected to the interface 212 in the apparatus 110 and a communication interface 304 in the test device 120. The communication interface 304 may include a transceiver-like component (e.g., a transceiver and/or a separate receiver and transmitter) that enables the test device 120 to communicate with other devices, such as via a wired connection, a wireless connection, or a combination of wired and wireless connections. The communication interface 304 may permit the test device 120 to receive information from another device, e.g., the apparatus 110, and/or provide information to another device. For example, the communication interface 304 may include an Ethernet interface, an optical interface, a coaxial interface, an infrared interface, an RF interface, a universal serial bus (USB) interface, a Wi-Fi interface, a cellular network interface, or the like.

The apparatus 110 may communicate detected RF signal levels and captured images, e.g., still and/or videos, to the test device 120 through the cable assembly 302. In other examples, the apparatus 110 may communicate wirelessly with the test device 120, for instance, through a Bluetooth^{TM} connection, a WiFi connection, or the like.

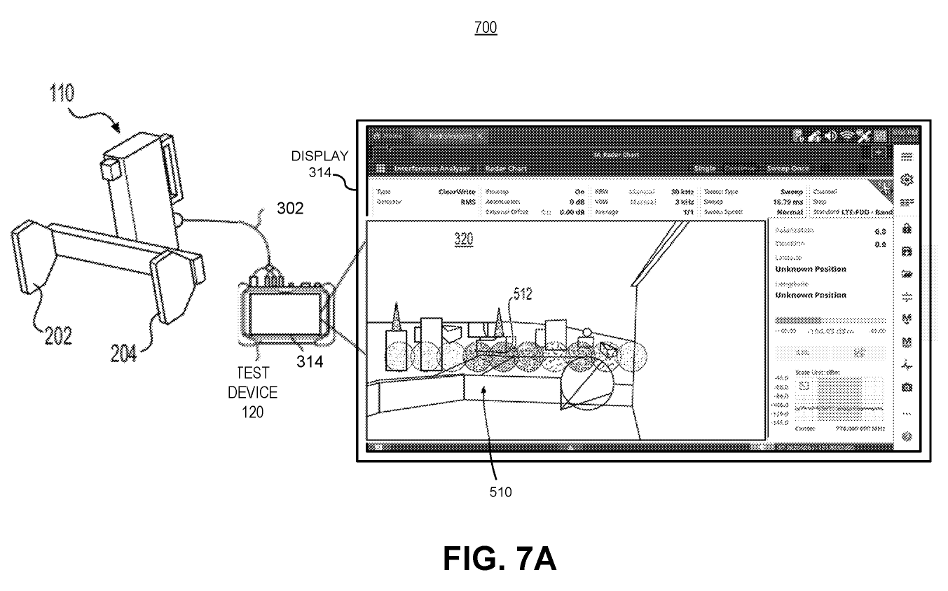

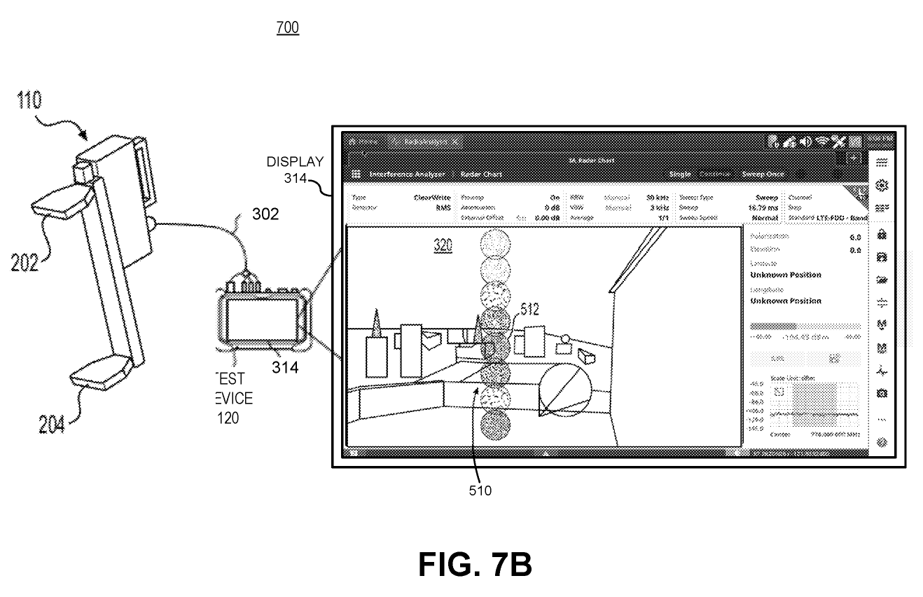

The test device 120 may include a processor 306, a bus 308, a memory 310, a spectrum analyzer 312, and a display 314. In some examples, the memory 310 may store instructions, e.g., machine-readable instructions, for the processor 306 to identify and visualize an angle of arrival of RF signals from an RF emitter as discussed herein. For instance, the processor 306 may determine a direction of arrival of detected RF signals and may cause an indication of the determined direction and the captured images to be displayed on the display 314. Particularly, the processor 306 may cause the display 314 to display images captured by the camera 220 and to display a heat map 510 (FIG. 7A) of the detected RF signal power levels as an overlay on the displayed images as discussed herein. The spectrum analyzer 312 of the test device 120 may identify signals from noise in detected RF spectrum.

The bus 308 may be a component that permits communication among the components of the test device 120. The processor 306 may be implemented in hardware, firmware, or a combination of hardware and software and may include one or more of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, the processor 306 includes one or more processors capable of being programmed to perform a function. The memory 310 may include one or more memories such as a random access memory (RAM), a read only memory (ROM), and/or another type of dynamic or static storage device (e.g., a flash memory, a magnetic memory, and/or an optical memory) that stores information and/or instructions for use by the processor 306.

The test device 120 may include components other than or in addition to those shown in FIG. 3. For example, the test device 120 may include a storage component that stores information and/or software related to the operation and use of test device 120. The storage component may be a hard disk (e.g., a magnetic disk, solid state disk, etc.) and/or another type of non-transitory computer-readable medium. The test device 120 may also include an input component that may include a component that permits the test device 120 to receive information, such as via user input (e.g., a touch screen display, a keyboard, a keypad, a mouse, a button, a switch, and/or a microphone). The test device 120 may further include an output component that may include a component that provides output information from the test device 120 (e.g., a display 314, a speaker, a user interface, and/or one or more light-emitting diodes (LEDs)).

The test device 120 may still further include a battery module that may be connected along the bus 308 to supply power to the processor 306, the memory 310, and other components of the test device 120. The battery module permits the test device 120 to be a portable integrated device for conducting field detection of RF interference. In some examples, the test device 120 may supply power to the apparatus 110 through the cable assembly 302. In other examples, the apparatus 110 may include a battery module to power the components of the apparatus 110.

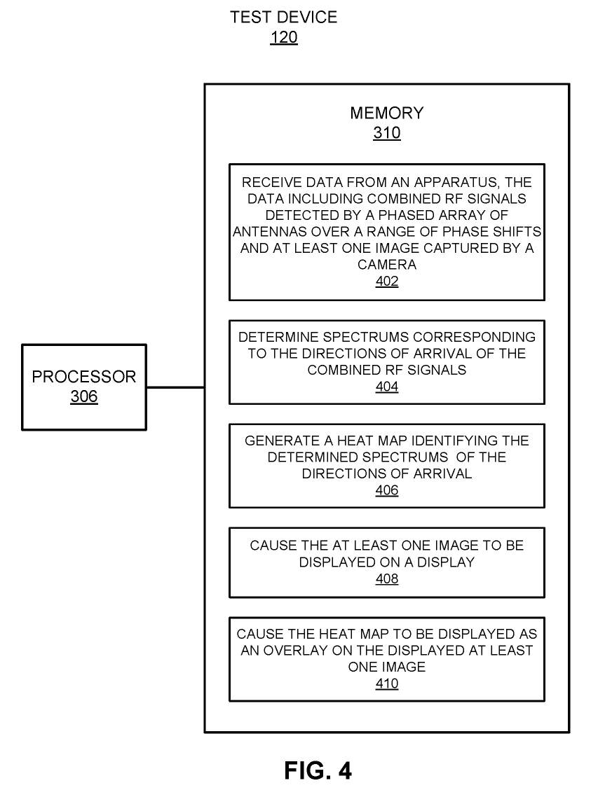

FIG. 4 shows a block diagram of the test device 120 shown in FIG. 3, and particularly, the processor 306 and the memory 310 of the test device 120, according to an example of the present disclosure. As shown, the memory 310 may store a set of machine-readable instructions 402-410 that the processor 306 may execute in identifying and visualizing an angle (or direction) of arrival of RF signals from an RF emitter.

According to examples, the processor 306 may execute the instructions 402 to receive data from an apparatus 110, for instance, through the cable assembly 302 that interconnects the test device 120 with the apparatus 110. The data may include combined RF signals detected by the first RF antenna 202 and the second RF antenna 204, in which the first RF antenna 202 and the second RF antenna 204 may be a phased array of RF antennas. For instance, the data may include power levels of the combined RF signal power levels. In addition, the combined RF signals may correspond to RF signals that the first and second RF antennas 202, 204 detected over a range of phase shifts. The data may also include at least one image captured by the camera 220 as well as a direction in which the apparatus 110 is facing, for instance as detected by the E-compass 218.

The processor 306 may execute the instructions 404 to determine spectrums corresponding to the directions of arrival of the RF signals. For instance, the processor 306 may employ the multiple signal classification (MUSIC) algorithm to estimate the directions of arrival of the RF signals received by the apparatus 110 over a range of phase shifts of the first RF antenna 202 and the second RF antenna 204. In implementing the MUSIC algorithm, the processor 306 may analyze the covariance matrix of the received RF signals to separate the signal subspace from the noise subspace. The covariance may represent the combined power of RF signals and noise and may also contain phase difference information. By projecting potential signal directions into the noise subspace, the MUSIC algorithm may identify directions where the projection is minimal, which may correspond to the directions of RF emitters. In other words, the processor 306 may identify the peak spectrum that occurs when the steering vector of the RF signals detected by the first RF antenna and the second RF antenna is orthogonal to noise as the peak angle (or direction) of arrival of RF signals from the RF emitter.

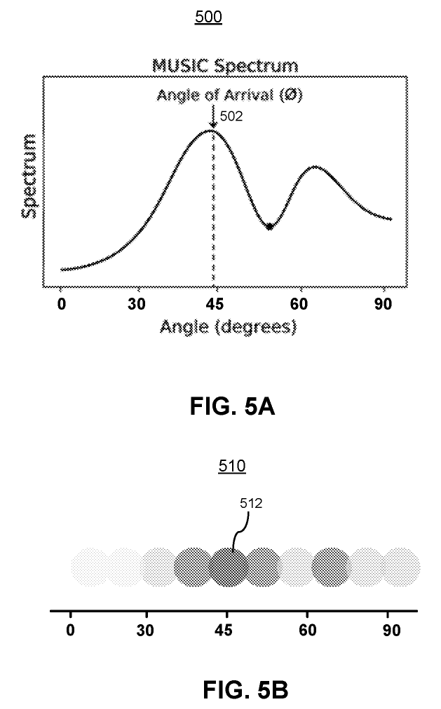

FIG. 5A shows a graphical representation 500 of a MUSIC spectrum resulting from an example spectrum determination operation, according to an example of the present disclosure. The graphical representation 500 includes an X-axis that may represent the directions or angles of arrival of the RF signals received by the first and second RF antennas 202, 204 in the apparatus 110. The graphical representation 500 also includes a Y-axis that may represent the power level of the RF signal measured at the direction or angle shown in the X-axis. A peak 502 on the graphical representation 500 may represent the likely direction or angle at which RF signals were received from an RF emitter.

With reference back to FIG. 4, the processor 306 may execute the instructions 406 to generate a heat map 510 identifying the determined spectrums, e.g., power levels, of the directions of arrival. FIG. 5B shows a diagram of a heat map 510 that corresponds to the graphical representation 500 shown in FIG. 5A, according to an example of the present disclosure. As shown in the heat map 510, the processor 306 may assign colors or other indicators corresponding to the spectrums, e.g., RF signal levels, of the RF signals having angles of arrival as shown in FIG. 5A. For instance, the processor 306 may represent lower RF signal power levels with lighter colors and may represent higher RF signal power levels with darker colors. In addition or alternatively, the processor 306 may represent the RF signal power levels with a range of colors. By way of particular example, the processor 306 may represent lower RF signal power levels with a yellow color, middle RF signal power levels with an orange color, and higher RF signal power levels with a red color.

The processor 306 may also position the colors or other indicators at their corresponding directions or angles of arrival on the apparatus 110, as also shown in FIG. 5B. According to examples, the processor 306 may assign a darkest or most prominent color 512 to the angle of arrival corresponding to the peak spectrum level.

The processor 306 may execute the instructions 408 to cause the at least one image received from the apparatus 110 on the display 314 of the test device 120. In addition, the processor 306 may execute the instructions 410 to cause the heat map 510 to be displayed as an overlay on the at least one image displayed on the display 314, for instance as shown in FIG. 7A. According to examples, the processor 306 may execute the instructions 402-410 while a user is pointing the apparatus 110 in a particular direction, for instance, in a test environment 100.

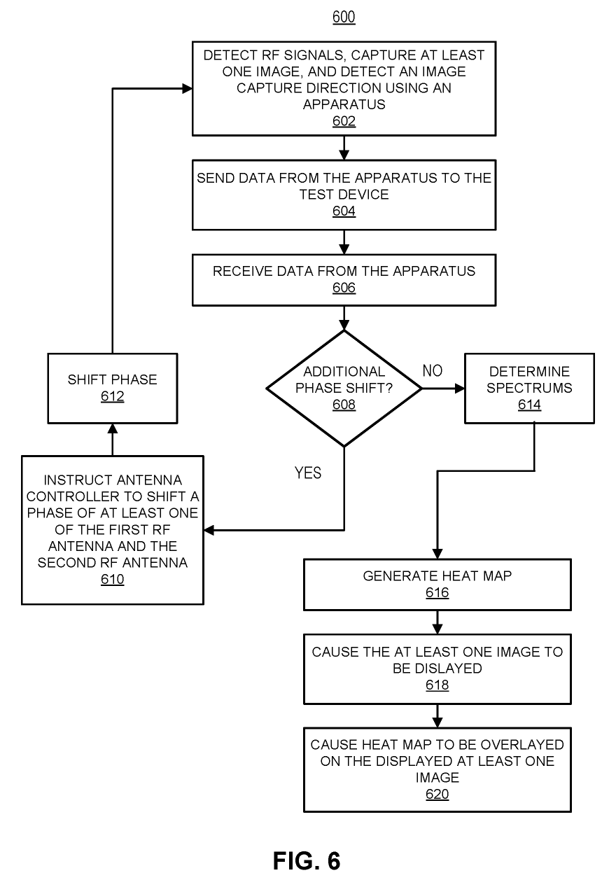

Various manners in which the apparatus 110 and the test device 120 of the system 300 may operate are described with respect to the method 600 shown in FIG. 6. Particularly, FIG. 6 shows a flow diagram of a method 600 for identifying and visualizing an angle of arrival of RF signals from an RF emitter, according to an example of the present disclosure. It should be understood that the method 600 may include additional operations and that some of the operations described therein may be removed and/or modified without departing from the scope of the method 600. The description of the method 600 is made with reference to the features depicted in FIGS. 1-5B for purposes of illustration.

At block 602, the first and second RF antennas 202, 204 of the apparatus 110 may be used to detect RF signals being emitted by an RF emitter that may be located in or around a direction in which the first and second RF antennas 202, 204 are facing. That is, a user of the apparatus 110 may point the apparatus 110 in a certain direction of interest such that the first and second RF antennas 202, 204 face the direction of interest to detect RF signals arriving from or around the direction of interest. According to examples, the first RF antenna 202 and the second RF antenna 204 form a phased array antenna and the phases of the first RF antenna 202 and the second RF antenna 204 may be set to steer a beam of RF signal reception to a certain direction.

While the first and second RF antennas 202, 204 detect the RF signals, the camera 220 may capture one or more images of objects and an environment in the field of view of the camera 220. In addition, the E-compass 218 may detect the direction or angle in which the first and second RF antennas 202, 204 are facing during the capture of the one or more images.

At block 604, the apparatus 110 may send data to the test device 120, in which the data may include the detected RF signals, e.g., combined RF signals. The data may also include the captured one or more images and the direction or angle in which the first and second RF antennas 202, 204 were facing when the one or more images were captured.

At block 606, the processor 306 of the test device 120 may receive the data from the apparatus 110. In addition, at block 608, the processor 306 may determine whether an additional phase shift is to be applied to the first RF antenna 202 and the second RF antenna 204 to steer the direction in which the RF signals are detected. The processor 306 may determine that an additional phase shift is to be applied based on, for instance, whether a predefined number of phase shifts, a predefined number of iterations, a predefined length of time, until the spectrum corresponding to the received RF signals has reached a peak and is decreasing, and/or the like, has occurred. Based on a determination that an additional phase shift is to applied, the processor 306 may, at block 610, instruct the antenna controller 208 of the apparatus 110 to shift a phase of at least one of the first RF antenna 202 and the second RF antenna 204. In addition, at block 612, the antenna controller 208 may cause the phase to be shifted as instructed.

The method 600 may also include, at block 602, detection of the RF signals at the shifted phase, e.g., the RF signal levels detected at the shifted phase, and at block 604, sending of the data including the RF signals detected at the shifted phase to the test device 120. Additionally, following receipt of the data from the apparatus 110 at block 606, the processor 306 may determine whether an additional phase shift is to be applied at block 608. Based on a determination that the additional phase shift is to be applied, the RF signals detected at the additional shifted phase may be detected and received by the processor 306.

However, based on a determination that an additional phase shift is not to be applied at block 608, the processor 306 may determine spectrums corresponding to the directions of arrival of the RF signals as indicated at block 614. For instance, and as discussed in greater detail herein, the processor 306 may determine the spectrums corresponding to the RF signals detected for multiple phase shifts. In other words, the processor 306 may determine the directions of the spectrums of the RF signals. Additionally, the processor 306 may determine the direction having the greatest spectrum as the direction of arrival of an RF signal from an RF emitter and may thus determine the direction of the RF emitter from the determined direction of arrival. The processor 306 may determine the spectrums as discussed herein with respect to FIGS. 4 and 5A.

At block 616, the processor 306 may generate a heat map 510 that graphically shows the determined spectrums, for instance, as colors or other indicators. The processor 306 may generate the heat map 510 as shown in FIG. 5B, for instance.

At block 618, the processor 306 may cause images captured by the camera 220 and received from the apparatus 110 to be displayed on a display 314 of the test device 120. In addition, at block 620, the processor 306 may cause the heat map 510 to be overlayed on the displayed captured images.

FIGS. 7A and 7B, respectively, show diagrams of a system 700 for identifying and visualizing a direction or angle of arrival of an RF emitter, according to an example of the present disclosure. The system 700 may be similar to the system 300 depicted in FIG. 3. In this regard, the system 700 may include an apparatus 110 and a test device 120, in which the apparatus 110 may be in communication through the cable assembly 302. As discussed herein, the apparatus 110 may communicate detected RF signal levels and captured images, e.g., videos, to the test device 120 through the cable assembly 302. In other examples, the apparatus 110 may communicate wirelessly with the test device 120, for instance, through a Bluetooth^{TM} connection, a WiFi connection, or the like.

According to examples, the test device 120 is to display the images received from the camera 220 of the apparatus 110 on the display 314 of the test device 120. An enlarged view of the display 314 is shown in FIG. 7A for purposes of illustration. As also discussed herein, the test device 120 may also display a heat map 510 of the detected RF signals received from the first and second RF antennas 202, 204 of the apparatus 110. Particularly, the test device 120 may convert the power levels of the RF signals received from the apparatus 110 into the heat map 510 as discussed herein. The test device 120 may overlay the heat map 510 with the displayed image 320 according to the directions of arrival of the detected RF signals. The direction of arrival of RF signals from an RF emitter may correspond to the darkest or otherwise distinguished indicator 512 in the heat map 510.

In the example shown in FIG. 7A, the first and second RF antennas 202, 204 may be arranged along a horizontal plane, which may result in the heat map 510 being shown as extending horizontally in the displayed image 320. In some examples, the first and second RF antennas 202, 204 may be arranged along a vertical plane as shown in FIG. 7B. In these examples, the heat map 510 may also be shown as extending vertically.

FIGS. 8A-8C, respectively, show perspective views of an apparatus 110 for identifying an angle of arrival of RF signals from an RF emitter, according to an example of the present disclosure. It should be understood that the test environment 100 and the apparatus 110 may include additional features and that some of the features described herein may be removed and/or modified without departing from the scopes of the present disclosure.

The apparatus 110 shown in FIGS. 8A-8C may be equivalent to the apparatus 110 shown in FIGS. 1-4 and may thus include all of the components described with respect to those figures. In this regard, the apparatus 110 may include an antenna array spacer 200, a first RF antenna 202, and a second RF antenna 204. The apparatus 110 may also include a chassis 800 and a handle 802 mounted to the chassis 800. A user of the apparatus 110 may maneuver the apparatus 110 into various positions through use of the handle 802. Additionally, the chassis 800 may house the other components of the apparatus 110 shown in FIG. 2 including the antenna controller 208, the interface controller 210, the processing unit 222, the GPS device 216, and the E-compass 218. The chassis 800 may also include one or more interfaces 212 through which the apparatus 110 may connect to the test device 120.

According to examples, the first RF antenna 202 and the second RF antenna 204 may be mounted on the antenna array spacer 200 such that the first RF antenna 202 and the second RF antenna 204 may be movable along the antenna array spacer 200. Particularly, for instance, the first RF antenna 202 and the second RF antenna 204 may be movable between multiple positions as shown in FIGS. 8A and 8B. The distance between the first RF antenna 202 and the second RF antenna 204 may thus be varied, which may vary the lambda (wavelength) of the RF signal under test. The lambda (wavelength) of the RF signal under test may be calculated as the speed of light (c) divided by the frequency of the RF signal (F). By way of particular example, while in the first position shown in FIG. 8A, the frequency of the RF signal under test may be 750MHz. Additionally, while in the second position shown in FIG. 8B, the frequency of the RF signal under test may be 3.75GHz.

According to examples, and as shown in FIG. 8D, the antenna array spacer 200 may include antenna spacer marks 810-816. Particularly, FIG. 8D shows a diagram of the antenna array spacer 200 with a plurality of antenna spacer marks 810-816, according to an example of the present disclosure. For instance, a first antenna spacer mark 810 and a fourth antenna spacer mark 816 may respectively correspond to positions of the first and second RF antennas 202, 204 to test RF signals of a first frequency as shown in FIG. 8A. Additionally, a second antenna spacer mark 812 and a third antenna spacer mark 814 may respectively correspond to positions of the first and second RF antennas 202, 204 to test RF signals of a second frequency as shown in FIG. 8B. In other examples, the antenna array spacer 200 may include additional antenna spacer marks corresponding to other frequencies of RF signals under test.

In some examples, a user may manually move the first RF antenna 202 and the second RF antenna 204 to be positioned at specific combinations of antenna spacer marks 810-816 to test RF signals having certain frequencies. The antenna spacer marks 810-816 may include an indication of the frequencies corresponding to the antenna spacer marks 810-816. In some examples, the user may input the frequency to be tested into the test device 120 and the test device 120 may instruct the user of the locations at which the first RF antenna 202 and the second RF antenna 204 are to be positioned on the antenna array spacer 200 to test the selected frequency.

In other examples, the antenna array spacer 200 may include a motor that may move the first RF antenna 202 and the second RF antenna 204 to the positions corresponding to a selected frequency. In this example, the processor 306 of the test device 120 may control the motor to move the first RF antenna 202 and the second RF antenna 204 to the selected positions. In any of these examples, the apparatus 110 may include gearing or another type of mechanism inside of the antenna array spacer 200 that may move the first RF antenna 202 and the second RF antenna 204. In addition, the antenna array spacer 200 and the first and second RF antennas 202, 204 may include mechanisms to hold the first and second RF antennas 202, 204 in place once the first and second RF antennas 202, 204 are moved to their intended positions to test RF signals having a certain frequency.

According to examples, the orientation of the antenna array spacer 200 and the first and second RF antennas 202, 204 may be varied between a horizontal orientation as shown in FIG. 8A and a vertical orientation as shown in FIG. 8B. In some examples, the antenna array spacer 200 may also be rotated such that the antenna array spacer 200 may be in a position that is between the horizontal and vertical positions. In any of these examples, the antenna array spacer 200 may be connected to the chassis 800 in any suitable manner that enables the antenna array spacer 200 to be rotated to a selected position and to remain at the selected position until the antenna array spacer 200 is moved again. In some examples, a motor may be positioned in the chassis 800 or the antenna array spacer 200 to rotate the antenna array spacer 200 with respect to the chassis 800, while in other examples, the antenna array spacer 200 may be manually rotated with respect to the chassis 800.

According to examples, the camera 220 may be positioned on an upper portion of the chassis 800 to enable the camera 220 to be able to capture images while the antenna array spacer 200 is in the vertical orientation as shown in FIG. 8C. In other examples, the camera 220 may be at a different location or may be movable such that the camera 220 may be repositioned when the antenna array spacer 200 is in the vertical orientation. In any of these examples, the camera 220 may capture images of an environment in a field of view of the camera 220 regardless of the orientation at which the antenna array spacer 200 is positioned.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims -- and their equivalents -- in which all terms are meant in their broadest reasonable sense unless otherwise indicated.

What is claimed is:

1. An apparatus for identifying an angle of arrival of radio frequency (RF) signals from an RF emitter, the apparatus comprising:
a chassis;
an antenna array spacer mounted to the chassis;
a first RF antenna connected to the antenna array spacer;
a second RF antenna connected to the antenna array spacer, wherein both the first RF antenna and the second RF antenna are movable along the antenna array spacer;
an antenna controller to output combined signals received by the first RF antenna and the second RF antenna; and
an interface controller to output the combined signals to a test device having a display, the test device comprising a processor to determine an angle of arrival of the combined signals.

2. The apparatus of claim 1, wherein the first RF antenna and the second RF antenna are RF directional antennas.

3. The apparatus of claim 1, further comprising:
a camera mounted to the chassis, wherein the camera faces a common direction as the first RF antenna and the second RF antenna and is to capture images in a field of view of the camera.

4. The apparatus of claim 3, further comprising:
a processing unit to output images captured by the camera to the test device, wherein the processor of the test device is to cause the captured images to be displayed on a display of the test device with an indication of the determined angle of arrival of the combined signals.

5. The apparatus of claim 1, wherein the antenna array spacer is mounted to the chassis to be rotatable with respect to the chassis.

6. The apparatus of claim 1, wherein the spacing between the first RF antenna and the second RF antenna directly influences a frequency of an RF signal being tested by the first RF antenna and the second RF antenna, and wherein the antenna array spacer comprises marks that identify locations at which the first RF antenna and the second RF antenna are to be positioned for a certain frequency of the RF signal to be tested.

7. The apparatus of claim 1, further comprising:
a global positioning system device housed in the chassis; and
an electronic compass housed in the chassis.

8. The apparatus of claim 1, further comprising:
a handle mounted on the chassis, the chassis housing an RF coupler to couple signals detected by the first RF antenna and the second RF antenna into the combined signals and to provide the combined signals to the antenna controller.

9. A system for identifying and visualizing a direction of arrival of radio frequency (RF) signals from an RF emitter, the system comprising:
a test device comprising:
a processor; and
a display; and
an apparatus comprising:
an antenna array spacer;
a first RF antenna movably mounted on the antenna array spacer;
a second RF antenna movably mounted on the antenna array spacer, wherein the first RF antenna and the second RF antenna are to be moved to vary a distance between the first RF antenna and the second RF antenna, and wherein the first RF antenna and the second RF antenna are to detect RF signals;
a camera to capture images in a field of view of the camera; and
wherein the detected RF signals and the captured images are to be outputted to the test device, and wherein the test device comprises a processor to determine a direction of arrival of the detected RF signals and to cause an indication of the determined direction of arrival and the captured images to be displayed on the display.

10. The system of claim 9, wherein the apparatus further comprises:
a chassis, wherein the antenna array spacer is mounted to the chassis.

11. The system of claim 10, wherein the antenna array spacer is rotatably mounted to the chassis.

12. The system of claim 9, wherein the distance between the first RF antenna and the second RF antenna is defined by a wavelength of an RF signal being tested, and wherein the antenna array spacer comprises marks that identify locations at which the first RF antenna and the second RF antenna are to be positioned for a certain frequency of the RF signal to be tested.

13. The system of claim 9, wherein the apparatus further comprises:
an antenna controller to combine RF signals received by the first RF antenna and the second RF antenna, wherein the antenna controller is to output the combined RF signals to the test device.

14. The system of claim 13, wherein the processor of the test device is to perform a multiple signal classification algorithm through:
control of phases of the combined RF signal received from the antenna controller to identify a peak spectrum that occurs when a steering vector of the RF signals detected by the first RF antenna and the second RF antenna is orthogonal to noise as a peak angle of arrival of the detected RF signals.

15. The system of claim 14, wherein the processor is to:
output instructions to the antenna controller to adjust the phases of the RF signals detected by the first RF antenna and the second RF antenna;
receive combined RF signals corresponding to the adjusted phases; and
determine the direction of arrival of the detected RF signals from the received combined RF signals.

16. The system of claim 9, wherein the processor is to cause the indication of the determined direction to be displayed as a heat map overlayed on the displayed captured images.

17. A method for identifying and visualizing an angle of arrival of radio frequency (RF) signals from an RF emitter, the method comprising:
receiving, by a processor of a test device, data from an apparatus, wherein the data comprises combined RF signals detected by a phased array of a first RF antenna and a second RF antenna over a range of phase shifts and at least one image captured by a camera;
determining, by the processor, an angle of arrival of the combined RF signals from the combined RF signals over the range of phase shifts;
causing, by the processor, the at least one image captured by the camera to be displayed on a display; and
causing, by the processor, the determined angle of arrival to be displayed as an overlay on the displayed at least one image.

18. The method of claim 17, further comprising:
outputting instructions to an antenna controller of the apparatus to adjust the phases of the RF signals detected by the first RF antenna and the second RF antenna;
receiving the combined RF signals corresponding to the adjusted phases from the antenna controller; and
determining the angle of arrival of the combined RF signals from the received combined RF signals corresponding to the adjusted phases from the antenna controller.

19. The method of claim 18, further comprising:
identifying a peak spectrum that occurs when a steering vector of the RF signals caused by the adjusted phases is orthogonal to noise, wherein a direction of the steering vector corresponds to the angle of arrival of the detected RF signals.

20. The method of claim 18, further comprising:
determining spectrums of the combined RF signals over the range of phase shifts;
generating a heat map corresponding to the determined spectrums of the combined RF signals over the range of phase shifts, wherein the heat map indicates the determined angle of arrival; and
causing the heat map to be displayed as the overlay on the displayed at least one image.
